(19) United States
(12) Patent Application Publication
(10) Pub. No.: US 2026/0103906 A1
(43) Pub. Date: Apr. 16, 2026

(54) Cleaning the Facades of Structures and Buildings Using a Device

(71) Applicant: Amir Rahimpour, Hochheim am main (DE)

(72) Inventor: Amir Rahimpour, Hochheim am main (DE)

(21) Appl. No.: 18/916,608

(22) Filed: Oct. 15, 2024

(51) Int. Cl. E04G 23/00; B08B 3/02; B08B 3/08; B08B 5/02

(52) U.S. Cl. CPC E04G 23/002; B08B 3/02; B08B 3/08; B08B 5/02

(57) ABSTRACT

This advanced building facade cleaning system addresses critical safety and environmental concerns. It eliminates the high risks associated with working at elevated heights, such as the dangers of falling and potential fatalities. Additionally, the system is designed to conserve water by utilizing it efficiently, ensuring optimal cleaning outcomes while minimizing water usage. The system offers flexibility in operation, functioning either in a three-stage or a two-stage process. It begins by synchronously cleaning from the top of the building-initially applying a cleaning agent, then washing with high-pressure water, and concluding with a thermal drying phase to prevent any staining. Alternatively, the facade can be cleaned using just the high-pressure water followed by thermal drying. This versatile system supports high-speed cleaning and can be deployed daily as required, promoting both safety and sustainability.

### 2. Overview

This disclosure relates to a novel apparatus designed to clean the façades of a variety of structures and buildings, thereby improving both the aesthetic appearance and service life of the façade.

### 3. DETAILED DESCRIPTION

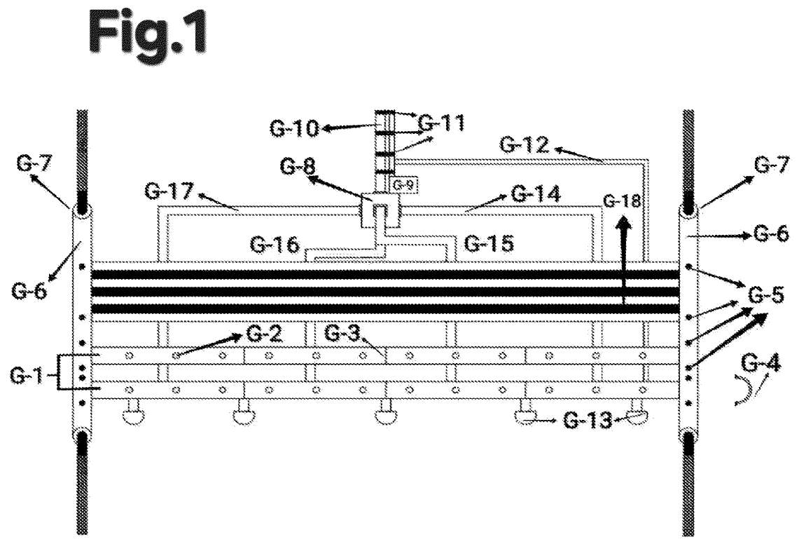

The invention is shown comprehensively in the accompanying drawing (FIG. 1). A front view of the fully assembled apparatus, ready for operation, is depicted there.

### 4. System Architecture

As illustrated in section G-1 (FIG. 1), the device comprises two horizontally aligned, parallel pipes equipped with nozzles. The lower nozzle dispenses cleaning agents (e.g., liquid detergents) to loosen dirt and deposits on the façade. Directly above it is a nozzle that sprays clean water at high pressure to rinse off the detergent and thoroughly clean the façade.

### 5. Mode of Operation

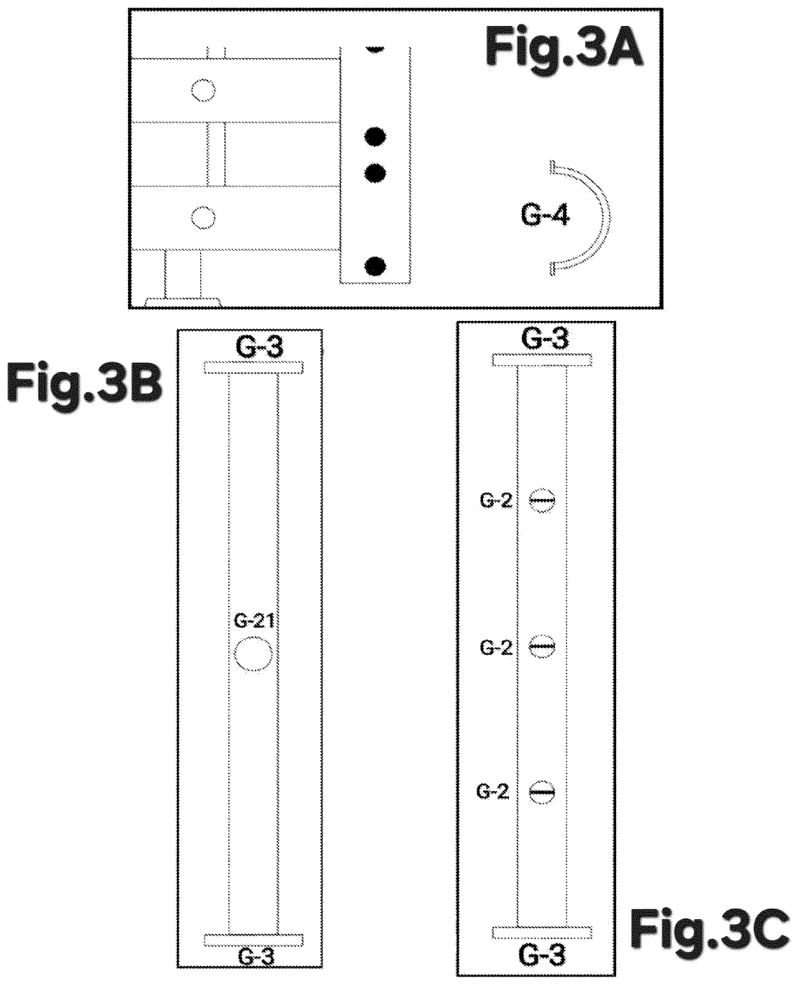

At regular intervals (G-2 in the drawing) nozzles spray high-pressure water that is essential for the cleaning process. To optimise water pressure throughout the system, certain segments of the lines are intentionally blocked (section G-3). These blockages ensure that water travels only short distances within each pipe segment, thereby maintaining its high pressure. Each isolated water-pipe segment has its own inlet; further details are given in G-21 (FIG. 3B).

### 6. Supporting structure and assembly

The dual-pipe system G-1 is fastened to the vertical support columns G-6 by means of brackets and clamps described in section G-4. Bolts and nuts (G-5) provide additional stabilisation. The vertical columns (G-6) carry not only the pipes but also other components of the apparatus. They are installed at the outer ends and at defined intermediate intervals to distribute and bear the overall weight at great heights evenly.

### 7. Stabilisation Concept

To increase stability, the vertical supports G-6 are fitted with eyes and hooks at both the top and bottom. These allow secure attachment to winches located above and below the building. By tensioning from both sides, the structure is reliably fixed, preventing wind-induced movement or uncontrolled contact with the façade. Section G-7 shows details of these connections and the anchor rings for the winch cables.

### 8. Water-Supply Details

Section G-8 describes a four-way water distributor that is essential for controlled distribution of high-pressure water within the system. This distributor receives water through hose G-10 coming from the building roof and then sequentially directs the water to hoses G-14, G-15, G-16 and G-17, each of which supplies the pipes G-1. Construction and operating principle of the four-way distributor are shown in the attached FIG. 1.

### 9. Advanced Control of Water Distribution

The multi-way distributor in section G-8 is controlled by an electric reverse-countdown switch G-9. This switch actuates the individual inlet valves to release or block the water flow in a targeted manner. At start-up, the switch opens the distributor outlets one after the other in reverse order. When the countdown expires, one outlet (e.g., G-14) is closed and the next (e.g., G-15) is opened, so that high-pressure water is systematically passed on. This sequence repeats from G-14 to G-17, ensuring a continuous operating cycle and effective cleaning.

### 10. Water Transfer and Protection

Section G-10 describes the high-pressure hose that conducts water from a roof-mounted pump to the water distributor G-8. Section G-11 explains the protective measures for system components, in which hoses and electrical lines are encased to prevent accidental contact with the façade and to avoid moisture damage.

### 11.electrical Infrastructure

Section G-12 describes the power supply for all electrical components, including the warning lights (G-13) and the heating-and-fan unit (G-18). This supply ensures constant and reliable energy delivery.

### 12. Safety Features

The warning lights G-13 are attached to the lower pipe G-1 with special clamps and emit optical and acoustic signals to warn people on lower storeys. These signals prompt them to keep windows closed and maintain safety distances during the cleaning process.

### 13. Hose and water-flow management

Sections G-14, G-15, G-16 and G-17 describe several short hoses that support water flow in the cleaning system. Each hose starts at one of the four outlets of the multi-way distributor G-8 and ends at its own inlet on pipe G-1, specifically at inlet G-21 (FIG. 3B). Through this configuration, water is gradually distributed through the nozzles in G-1: first G-14 opens, then-after a preset time-G-15, and so on. The entire façade is thus cleaned section by section while only a single pump is needed in a rotating sequence.

### 14. Alternative High-Speed Cleaning Modes

An alternative operating mode uses more powerful pumps to increase throughput and prevent pressure drops in the pipe system. The step-wise switching (reverse-countdown) is skipped so that all nozzles can run simultaneously. The entire façade width can therefore be sprayed and cleaned within seconds, significantly shortening cleaning time.

### 15. Dual-Pipe Function

As already mentioned, device G-1 contains two parallel horizontal pipes. The spraying and cleaning functions described above refer to the upper pipe. The lower pipe performs a comparable task but also dispenses cleaning agent (e.g., soap solution). While the lower pipe wets the façade with detergent, the upper pipe subsequently rinses with clean water. Both pipes have their own pumps, hoses, water distributors and reverse-countdown switches and can be operated independently.

### 16. Drying System

Section G-18 provides a fan-assisted heating system that dries the façade after cleaning. Warm air is directed over the moist surface and speeds up drying to avoid damage from residual moisture.

### 17. Overall Layout of the Cleaning Installation

For better clarity, system G-1 is adapted in its width to the respective building façade so that the entire surface is covered during cleaning. The pipes are horizontally aligned in front of the façade and secured by several vertical supports (G-6) and clamps (G-4) with bolts and nuts. Nozzles are installed at defined intervals on the pipes G-1 to ensure even water distribution. Multiple water distributors (G-8), connected to the pipes via short hoses (G-14-G-17), direct high-pressure water into the upper pipes G-1. Likewise, the lower pipe G-1 supplies soap or cleaning agent instead of clear water to foam the façade before it is rinsed by the upper pipe. Above the G-1 pipes is the heating system G-18 with fan. Electrically heated metal elements warm up and, together with the fan, transfer heat to the façade for rapid drying.

### 18. Heat Focusing and Protection

Behind the fan and the heated metal elements is a metal plate that focuses heat forward towards the façade and prevents cold outside air from disturbing heat application. It also protects the heating elements against external influences (e.g., birds or splashing water from below).

### 19. Arrangement and Safety Measures

The G-1 pipes are arranged in a lower row with the nozzles pointing slightly downward toward the façade, preventing water from accidentally spraying upward toward the heating modules. Should spray occur, the above-mentioned metal plate reliably shields the heating elements. After the cleaning process, the heating system G-18 is activated to dry the façade at a predefined temperature. The power supply (G-12) for G-18 and the warning lights G-13 runs from the top of the building to the devices and is shielded as per G-11. To move or fix the apparatus vertically, several winches are employed, anchored to the vertical columns G-6 (see section G-7). This allows the system to be raised and lowered precisely while remaining stable throughout operation.

### 20. Winch System and Operational Coordination

Each vertical column G-6 has a matching winch at the top, connected via steel cables to the upper hooks G-7. Additional winches are positioned at ground level interacting with the lower hooks G-7. This twin-winch system permits precise height adjustment of the entire cleaning device in front of the façade and prevents lateral or rotational swinging. The timing of the winches is synchronised with the complete washing cycle, especially the timing specifications of the electric reverse-countdown switch G-9. Once the lower pipe applies detergent and the upper pipe rinses with clear water, the device is lowered by winch to the next horizontal façade level. After each cleaning cycle the winches coordinate the downward movement so that the lower pipe can now dispense detergent at the new position while the upper pipe rinses the previously cleaned area. Spraying is interrupted during lowering to save water; once the new position is reached, spraying resumes.

### 21. Support Structure and Safety Aspects

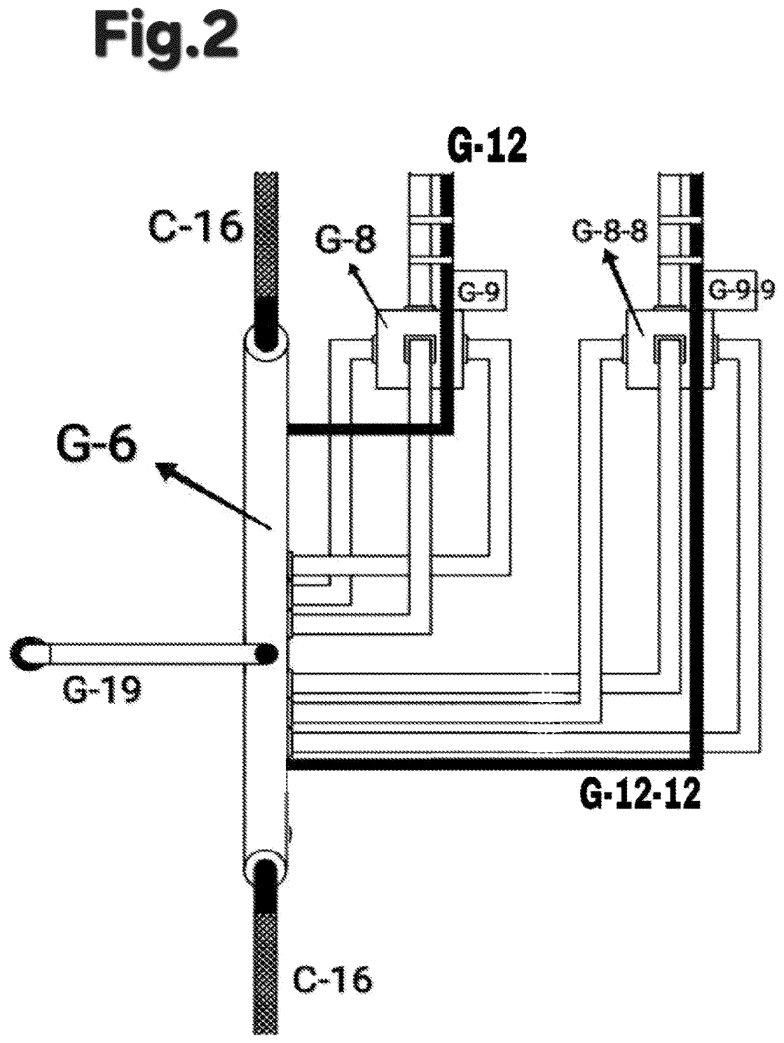

FIG. 2 (side view from the left) again shows vertical column G-6 serving as a central support. Section C-16 describes hooks and clamps at the top and bottom of the column that couple to winches to stabilise the device and avoid wind fluctuations. In G-19 a horizontal beam attached to the vertical column G-6 is described. At its end are small gel-filled wheels that provide gentle cushioning should the device come too close to the façade, preventing damage to the building and the cleaning apparatus.

### 22. Soap Dispensing System

Section G-8-8 (FIG. 2) shows a water distributor connected to the lower pipe G-1 to dispense liquid cleaning agent (cf. FIG. 1). Short auxiliary hoses enable targeted application of the cleaning liquid. Section G-9-9 describes a special switch for the reverse-countdown mechanism that controls opening and closing of the distributor (G-8-8) for soap delivery.

### 23. Water Distribution for the Upper Pipe

Sections G-8 and G-9 deal with the water-distribution system on the upper pipe G-1 and the associated countdown switch. This system is specifically designed to spray clear water so that the façade is efficiently rinsed after soaping.

### 24. Power Supply for the Heating System

Section G-12 describes the electrical wiring that powers the fan-heater system used for drying the façade. This is critical to ensure fast and even drying.

### 25. Electrical Wiring for Safety Functions

Section G-12-12 explains the wiring of the warning lights beneath the lower pipe G-1. These lights signal to building occupants that the cleaning device is in front of their windows, preventing accidents.

### 26. Detailed Assembly Illustrations

FIG. 3A (front view): An enlarged illustration showing how the pipes G-1 are fastened to vertical column G-6 (see FIG. 1). The pipes are stably mounted with clamps and connectors (G-4) as well as bolts and nuts.

### 27. Pipe Design and Function (FIG. 3B, Rear View)

FIG. 3B enlarges the rear side of pipes G-1 (FIG. 1). Pipe ends G-3 are sealed to prevent water leakage. Special external rims at both ends enable modular connections so that pipe length can be adjusted as needed. Section G-21 shows the single inlet per pipe through which high-pressure water is introduced by a hose.

### 28. Nozzle Arrangement and Pipe Sealing (FIG. 3C, Front View)

FIG. 3C (front view) again shows pipe G-1 (FIG. 1). At spacings G-2 water-outlet nozzles are installed that spray high-pressure water onto the façade. The regions marked G-3 at the pipe ends are sealed to maintain pressure in the pipe and ensure water exits with sufficient force. Additional grooves and projections at the pipe ends enable independent and secure connection of further pipe segments.

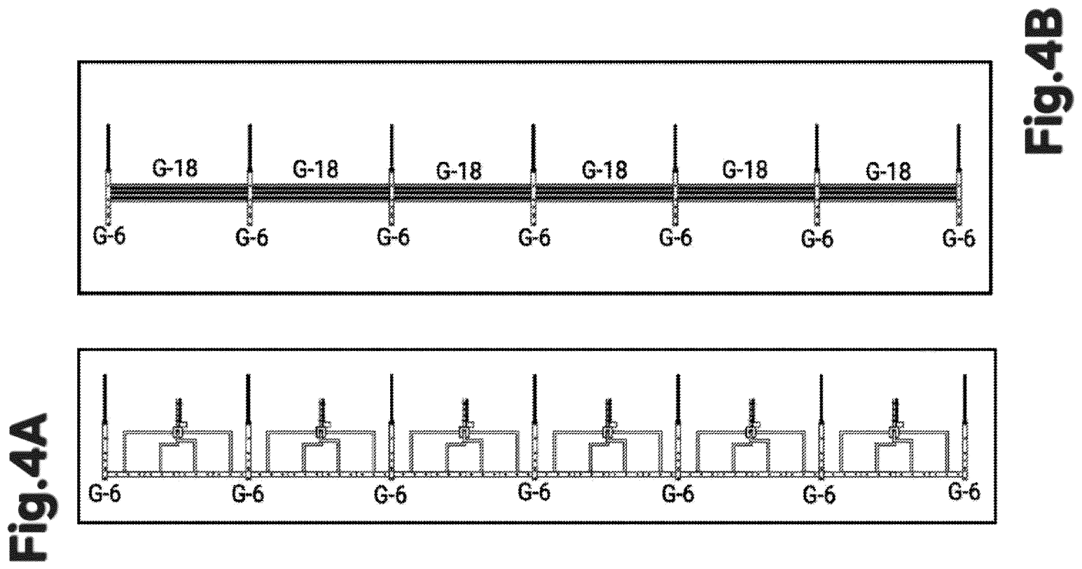

### 29. Complete Façade View (FIG. 4A, Front View)

FIG. 4A shows the entire facade-cleaning system in a front view, with the heating system omitted (depicted separately in FIG. 4B). Under number 1 the large-scale system spanning the full width of a tall building is visible. It is fixed to regularly arranged columns G-6 to ensure stability in front of the façade and minimise wind effects.

### 30. Detailed View of the Heating System (FIG. 4B)

FIG. 4B, analogous to FIG. 4A, shows only the heating system G-18. It is mounted above the washing pipes and ensures thorough drying of the previously cleaned surfaces. It is attached at several points to the columns G-6 to achieve even heat distribution over the entire façade.

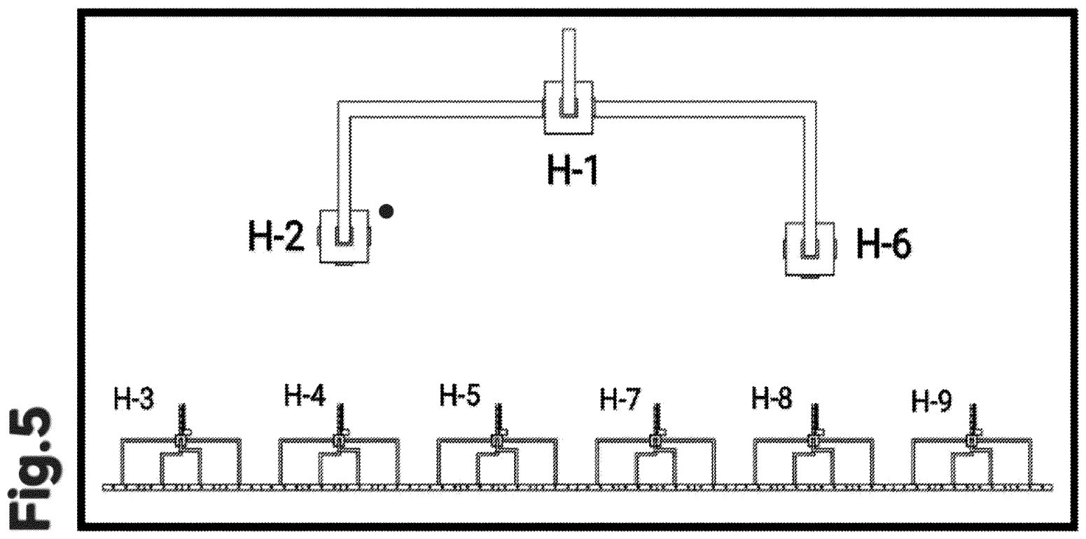

### 31.Overview of Water Supply (FIG. 5, Front View)

FIG. 5 shows a high-pressure water-supply system that optimises resource usage. The system starts at section H-1, where high-pressure water enters from a pump via a hose. A one-minute countdown initiates sequential forwarding of the water: from H-1 to H-2, then within 20 seconds to H-3, and finally back to the first inlet connected to pipe G-1. Pipe G-1 has multiple nozzles to spray water extensively onto the façade.

### 32. Sequential Water Transfer and Spraying Function (H-3)

Initially H-3 directs high-pressure water for 5 seconds from the first inlet to activate the nozzles from left to right. It then switches for another 5 seconds to the second inlet, etc. This pattern repeats so that all outlets are activated and the façade is cleaned evenly.

### 33. Comprehensive Cleaning Cycle (Coordination H-2 and H-4)

After about 4-5 seconds each, i.e., roughly 20 seconds total, the distribution system switches high-pressure flow from H-2 to the next section. H-4 operates synchronously in a similar manner. Once the 20-second countdown in H-2 has elapsed, the flow at H-4 switches from the second inlet to H-5. This 20-second cycle repeats three times (total 60 seconds), cleaning half the façade. Simultaneously, after 1 minute H-1 switches from the first to the second inlet and then to H-6. The same sequence repeats as previously in H-2, so that the other half of the façade is now treated. This structured procedure enables comprehensive and systematic cleaning of the entire building exterior.

### 34. Progressive Washing Cycle

The cleaning process starts at the top of the building and moves gradually downward. After completing one horizontal row, the apparatus is lowered by winches to wash and dry the next row. This process is repeated until the entire façade from top to bottom has been cleaned.

### 35. Control Options

The system can be operated manually by an operator or automatically through a control centre on the building. There, power supply, winches, high-pressure and detergent pumps, and the drying system are controlled. Safety measures such as emergency-stop switches are integrated to ensure safe operation.

### 36. Initial Activation and Positioning

At the start of the cleaning process all winch-connected components are activated simultaneously by the control centre. The winches lower the apparatus by a preset value (e.g., 50 cm) so that the detergent nozzles are positioned directly in front of the windows or façade.

### 37. Cleaning and Drying Cycle

After reaching position, the winches stop. The high-pressure pump for detergent is activated and applies soap over the façade from one side to the other for a defined period. It then switches off, and the clear-water pump switches on to rinse the facade. After the set washing time the winches lower the system another 50 cm while the drying system (heater with fan) dries the area just cleaned.

### 38. Simultaneous Washing and Drying

At this phase the drying system G-18 is activated by the control centre to dry the upper area already cleaned, while the high-pressure soap pump is started again to treat the next lower façade area. This parallel procedure increases efficiency and shortens overall operating time.

### 39. Adaptability of the Sequential Process

After soaping, clear-water rinsing starts to clean another façade row. The operating time of the drying system depends on the required drying degree. For longer drying times the heater remains on continuously; for shorter intervals it is temporarily deactivated once a row is sufficiently dry.

### 40. Completion of the Cleaning Operation

This systematic process continues row by row from top to bottom. After the final row both the high-pressure water pump and the detergent pump are switched off. The heating system stops once the last row is dry. The entire system is then winched back up, ready for the next cleaning or maintenance cycle.

### 41. Programmability and Control Flexibility

The equipment described supports various automation algorithms, one of which has been explained as an example. Through a control centre with PLC it is possible to define sequences, priorities and schedules individually. Alternatively, manual operation by an operator is possible to meet specific building requirements.

### 42. Additional Safety and Monitoring Functions

To ensure safe and trouble-free operation, the following additional elements can be integrated:

### A. Winch Sensors

Sensors on each winch detect blockages or free-running.
If abnormal behaviour is detected, a signal is sent to the central control to stop the entire system until the problem is resolved.
This prevents one-sided pulling that could cause deformation or dangerous misalignment.

### B. Temperature Monitoring and Thermostat

A thermostat or temperature sensor continuously measures the temperature of the heating elements and, if required, the façade surface.
If the temperature exceeds a defined limit, the heating system switches off automatically to avoid overheating and potential fire hazard.
Optionally a warning light or message in the control centre alerts maintenance staff.

### C. Adjustable Distance Between Heater and Spray Pipes

The design allows the position of the heating element (G-18) to be adjusted relative to the pipes G-1.
A defined minimum distance prevents spray water from reaching the heating elements, reducing risk of short circuits or corrosion.

### D. Covers and Housings

The heating element is enclosed by a housing open only toward the façade and sealed on the sides and back, preventing water ingress.
Additional covers between the spray area (nozzles G-2) and the heating unit (G-18) as well as warning lights (G-13) keep moisture away from sensitive components.

### E. Regular Maintenance and Corrosion Protection

To avoid rust formation in the pipes and clogging of the nozzles (G-2), regular maintenance is recommended.
This includes flushing lines with corrosion inhibitors, replacing filters and seals, and inspecting all valves and blockages (section G-3).

### F. Camera and Remote Monitoring

One or more cameras can be mounted at suitable points to monitor the façade condition and the operation of winches and spray nozzles remotely.
Live video or recording enables maintenance staff to react quickly to malfunctions and, if necessary, shut down the system remotely.

### Summary and Significance of the Invention

The façade-cleaning system presented here uses modern technology and automation to make cleaning large buildings more efficient and faster. Precise control of washing and drying cycles allows high adaptability to different building requirements. In addition to improving hygiene and aesthetics, the system also contributes to environmental protection through reduced water and energy consumption.

1. A building facade cleaning system comprising:
a plurality of vertically aligned modules configured to traverse the height of a building facade, each module including:
a high-pressure water spray device for discharging water onto the facade,
a detergent dispensing device for applying cleaning agents to the facade,
a thermal drying device to dry the facade post-cleaning,
a high-pressure water distribution system where the water is supplied by a pump through section H-1 and sequentially transferred through multiple inputs (H-2, H-3, H-4, H-5, and H-6) using a reverse countdown mechanism, allowing the water to be distributed across different sections of the facade at intervals of 20 seconds,
the system further includes an option to operate with a high-powered pump that allows for simultaneous activation of all nozzles for water discharge.

2. The system of claim 1, further comprising a central control system equipped with a Programmable Logic Controller (PLC) for controlling the operation of the high-pressure water spray and detergent dispensing devices.

3. The system of claim 1 wherein winches are used to adjust the height of the cleaning modules, allowing systematic cleaning from the top to the bottom of the building facade.

4. The system of claim 1 comprises water spray devices equipped with multiple nozzles that discharge high-pressure water in a uniform and sequential manner across the building facade.

5. The system of claim 1 includes a thermal drying device mounted above the cleaned facade, applying heat uniformly to ensure efficient drying of the facade.

6. The apparatus of claim 1 wherein the dispensing of detergent and clean water is automatically and sequentially controlled by the central control system.

7. The system of claim 1 includes manual control options, allowing an operator to adjust the cleaning process to the specific needs of the building.

8. The system of claim 1 features separate pipe segments designed to maintain water pressure by intentionally obstructing certain sections of the pipes, ensuring high-pressure water is evenly distributed through the system and discharged effectively from the nozzles.

9. The system of claim 1 operates automatically through programmable algorithms controlled by the PLC, optimizing water and energy usage to minimize environmental impact.
